(19) United States
(12) Patent Application Publication
(10) Pub. No.: US 2011/0141908 A1
(43) Pub. Date: Jun. 16, 2011

(54) WIRELESS TRANSMITTING DEVICE AND WIRELESS RECEIVING DEVICE

(75) Inventors: Chie Ishida, Kanagawa (JP); Hong Tat Toh, Singapore (SG)

(73) Assignee: PANASONIC CORPORATION, OSAKA (JP)

(21) Appl. No.: 13/058,318

(22) PCT Filed: Jul. 31, 2009
(86) PCT No.: PCT/JP2009/003653

§ 371 Date: Feb. 9, 2011

(30) Foreign Application Priority Data
Aug. 12, 2008 (JP) 2008-207760

(51) Int. Cl. H04W 72/04; H04L 12/26

(52) U.S. Cl. 370/241; 370/312

(57) ABSTRACT

A wireless transmitting device (10) comprises an MBMS data transmitting unit (14) transmitting MBMS data, an MBMS control information generating unit (13) generating MBMS control information comprising access barring information, and a transmitting unit (19). A wireless receiving device comprises a data receiving unit receiving MBMS data, a control information receiving unit receiving MBMS control information comprising access barring information, an access class control unit performing access class control on the basis of the MBMS control information, and an RACH preamble transmitting unit transmitting an RACH preamble on the basis of the result of the access class control. Thus the wireless transmitting device and the wireless receiving device can maintain an acceptable chance of successful connection establishment by wireless communication devices that do not receive MBMS, without reducing customer satisfaction in a cell that provides MBMS.

### CROSS REFERENCE TO RELATED APPLICATION

This application is based upon and claims the benefit of priority from the prior Japanese Patent Application No. 2008-207760, filed on Aug. 12, 2008, the entire contents of which are incorporated herein by reference.

### TECHNICAL FIELD

The present invention relates to a wireless communication technical field and, in particular, to a wireless transmitting device that provides multimedia broadcast/multicast services (hereinafter abbreviated as “MBMS”) and a wireless receiving device that receives the services.

### BACKGROUND ART

When a wireless communication device in an idle state initiates a connection setup procedure, the wireless communication device needs to transmit a signal onto a network by following some procedure in order to establish a dedicated channel between the wireless communication device and a base station device. To transmit the signal from the wireless communication device onto the network, a Random Access Channel (hereinafter abbreviated as “RACH”), which is an uplink common physical channel called, is used.

The wireless communication device uses a preamble for measuring the reception level of a Downlink Pilot Time Slot (hereinafter abbreviated as “DwPTS”), detecting an RACH attempt, and estimating the arrival timing to determine transmission power. To avoid collisions between multiple wireless communication devices that use the same slot at the same time, a sequence called signature is used in a preamble. Preambles with different signatures can be distinguished and detected when the preambles are received at the same time. Accordingly, a collision can occur only when both access slot and signature are identical and the possibility of collision between preambles transmitted from multiple wireless communication devices is generally low. However, on rare occasions, preambles transmitted from multiple wireless communication devices in a cell collide.

FIG. 14 is a diagram illustrating an access class control operation for reducing the possibility of collision between preambles. A base station 100 transmits access barring information, which is an item of system information, through a Downlink Shared Channel (hereinafter abbreviated as “DL-SCH”) (S200), which is a transport channel. The access barring information comprises a threshold value (hereinafter referred to as “access probability factor”) which is used for access class control and determines whether access is allowed or not, and a default value used for calculating a barring timer.

A terminal 102 that received the access barring information determines whether to connect to the base station 100 (S202). If the terminal 102 connects to the base station 100 (YES at S202), the terminal 102 performs access class control before transmitting a random access preamble (hereinafter also referred to as “RACH preamble”). Specifically, the terminal 102 compares a random value generated locally by the terminal with the access probability factor indicated in access barring information (S204). If the random value is smaller than the access probability factor (YES at S204), the terminal 102 transmits an RACH preamble (S206). On the other hand, if the random value is greater than or equal to the access probability factor (NO at S204), the terminal 102 calculates the value of the barring timer (S208), initiates the barring timer (S210), and waits until timeout of the barring timer. After the timeout of the barring timer (S212), the terminal 102 proceeds to step S204, where the terminal 102 compares a random value with the access probability factor. The value of the barring timer is calculated by multiplying a default value transmitted in system information by a random value for the barring timer generated on the terminal 102. Since different terminals 102 initiates transmission of RACH preambles at different times in this way, the possibility of collision between RACH preambles can be reduced. Access class control is described in Patent Literature 1 and Non Patent Literature 1 and 2.

### CITATION LIST

### Patent Literature

Patent Literature 1: Japanese Patent Application Publication No. 2006-505979

### Non Patent Literature

Non Patent Literature 1: 3GPP TS36.331 V8.2.0 “Evolved Universal Terrestrial Radio Access (E-UTRA) Radio Resource Control (RRC)”
Non Patent Literature 2: 3GPP TSG RAN WG2 meeting #61bis R2-081737, “Access Class barring enhancements to support PPAC”, NTT DoCoMo, Inc.

### SUMMARY OF INVENTION

### Problem to be Solved by the Invention

In the field of mobile communication, technical studies on MBMS, which is broadcast or multicast services, are being conducted. MBMS provides one-to-many communication rather than one-to-one communication, where one base station device transmits the same data (for example music data or video image data) to multiple terminal devices at the same time.

In unicast communication, when a base station device uses individual dedicated channels to broadcast information such as streaming service information, the load on the wireless network increases as the number of terminal devices that attempt to receive the information increases. In contrast, MBMS has an advantage that the number of terminal devices that can receive information can be increased without increasing the load on the wireless network because all terminal devices use the same channel to receive information even when the number of terminal devices is increased. MBMS-based services under consideration include traffic information distribution, music distribution, news distribution, and sports broadcast.

When a MBMS-based service is provided, many terminals will attempt to access to a cell that provides the MBMS service. When many terminals attempt to access a particular cell, the number of RACH preambles transmitted from the terminals increases accordingly. As a result, disadvantageously, transmission of RACH preambles is blocked by access class control and even terminals that do not receive the MBMS service cannot establish connections to the base station. The problem can also arise among different frequency bands provided by a single base station as well as on a cell-by-cell basis.

FIG. 15 is a diagram illustrating an example of frequency allocation by a base station that provides a MBMS service. In FIG. 15, one base station manages three different frequencies (f_x, f_y, and f_mbms). Two frequencies (f_x and f_y) provide only a unicast service and the other frequency (f_mbms) provides both unicast and MBMS services. Here, if many terminals attempt to access the MBMS service, it is to be anticipated that the frequency f_mbms that provides the MBMS service will be crowded while the frequencies f_x and f_y are relatively uncrowded.

The present invention has been made in light of these circumstances and an object of the present invention is to provide a wireless transmitting device and a wireless receiving device that maintains an acceptable chance of successful connection establishment of wireless communication devices that do not receive MBMS in a cell that provides MBMS, without reducing user satisfaction.

### Means for Solving the Problems

A wireless transmitting device of the present invention comprises a data transmitting unit transmitting MBMS data and a control information transmitting unit transmitting MBMS control information comprising access barring information.

A wireless receiving device of the present invention comprises a data receiving unit receiving MBMS data, a control information receiving unit receiving MBMS control information comprising access barring information, an access class control unit performing access class control on the basis of the MBMS control information, and a random access preamble transmitting unit transmitting a random access preamble on the basis of a result of the access class control.

### Advantages of the Invention

With this configuration, access barring information is transmitted to terminals that receive an MBMS service but is not provided to terminals that do not receive the MBMS service. Accordingly, access class control is applied only to the terminals that receive the MBMS. Since the terminals that receive the MBMS service perform access class control on the basis of access barring information included in MBMS control information, connection establishment by the terminals that receive the MBMS service is limited and accordingly an acceptable chance of successful connection establishment by the terminals that do not receive the MBMS service can be maintained.

There are other modes of the present invention as will be described later. Therefore the disclosure of the present invention is intended to provide part of the present invention and is not intended to limit the scope of the present invention described and claimed herein.

### BRIEF DESCRIPTION OF DRAWINGS

FIG. 1 is a diagram illustrating a configuration of a base station in a first embodiment.

FIG. 2 is a diagram illustrating a configuration of a terminal in the first embodiment.

FIG. 3 is a diagram illustrating a network to which the first embodiment is applied.

FIG. 4 is a diagram illustrating signaling operations in the first embodiment.

FIG. 5 is a diagram illustrating an example of access barring information.

FIG. 6 is a diagram illustrating an operation of a base station in the first embodiment.

FIG. 7 is a diagram illustrating an operation of a terminal in the first embodiment.

FIG. 8 is a diagram illustrating a configuration of a terminal in a second embodiment.

FIG. 9 is a diagram illustrating signaling operations in the second embodiment.

FIG. 10 is a diagram illustrating an operation of a terminal in the second embodiment.

FIG. 11 is a diagram illustrating a configuration of a terminal in a third embodiment.

FIG. 12 is a diagram illustrating signaling operations in the third embodiment.

FIG. 13 is a diagram illustrating an operation of a terminal in the third embodiment.

FIG. 14 is a diagram illustrating a conventional access class control operation.

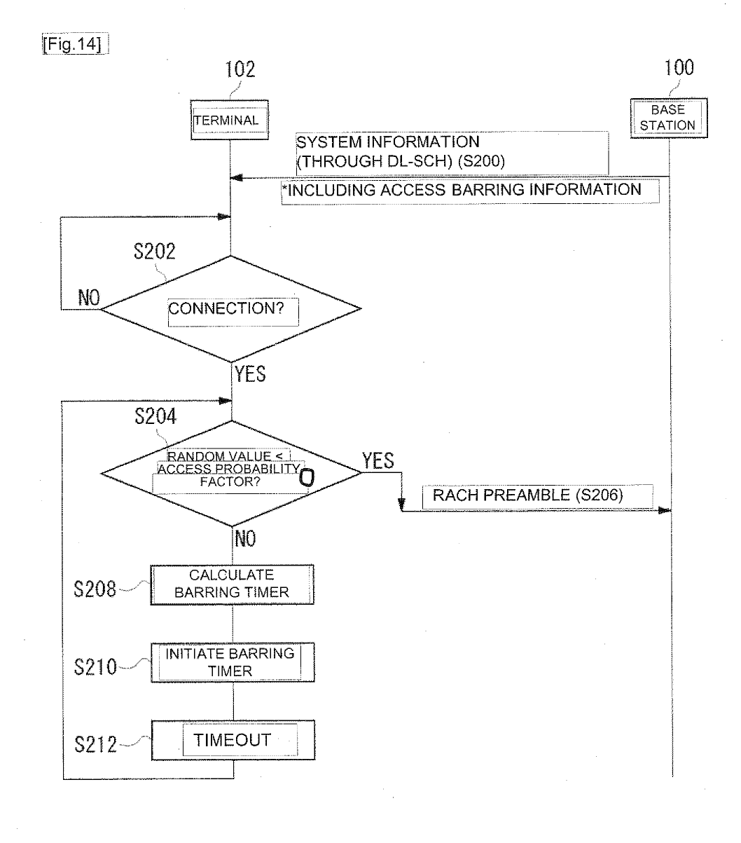

FIG. 15 is a diagram illustrating an example of frequency allocation by a base station providing an MBMS service.

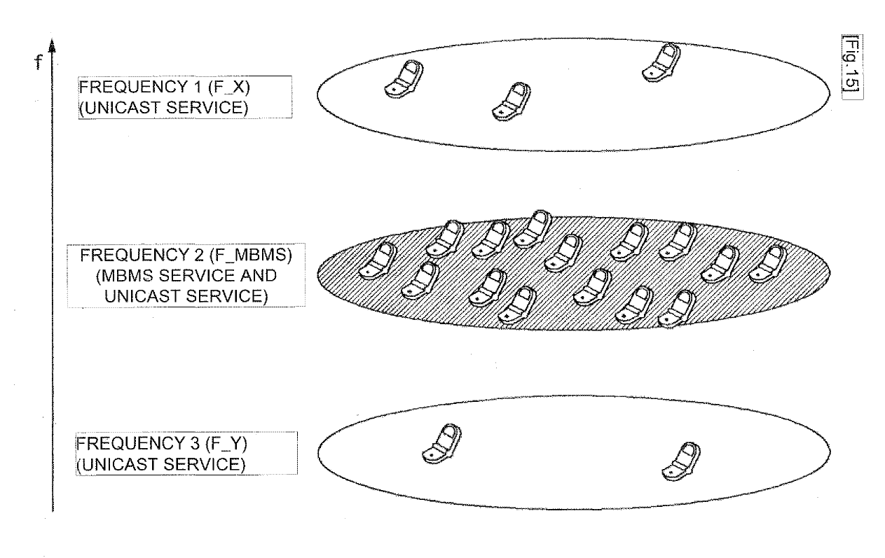

### DESCRIPTION OF EMBODIMENTS

The present invention will be described in detail below. Embodiments described below are illustrative only and various modifications can be made to the present invention. Therefore, specific configurations and functions disclosed below are not intended to limit the scope of the claims.

A wireless transmitting device according to an embodiment comprises a data transmitting unit transmitting MBMS data and a control information transmitting unit transmitting MBMS control information comprising access barring information.

With this configuration, access class control is applied only to the terminals that receive an MBMS service because the access barring information is transmitted only to the terminals that receive an MBMS service and is not transmitted to terminals that do not receive the MBMS service. By applying access class control to the terminals that receive the MBMS service, an acceptable chance of successful connection establishment by terminals that do not receive the MBMS service can be maintained.

The access barring information used by the wireless transmitting device according to the present embodiment is information that enables different access class controls for different MBMS services.

With this configuration, the chance of successful connection establishment can be controlled according to the type of MBMS service that the terminal is receiving. For example, control can be performed that allows a terminal that receives an unpopular MBMS service to have a higher chance to establish a connection than a terminal that receives a popular MBMS service.

The access barring information used by the wireless transmitting device according to the present embodiment can include priority of each individual MBMS service.

This configuration enables terminals to determine whether to continue to receive an MBMS service or to establish another connection, on the basis of the priority of each MBMS service.

A wireless receiving device according to the present embodiment comprises a data receiving unit receiving MBMS data, a control information receiving unit receiving MBMS control information comprising access barring information, an access class control unit performing access class control on the basis of the MBMS control information, and an random access preamble transmitting unit transmitting a random access preamble on the basis of a result of the access class control.

With this configuration, since terminals that receive an MBMS service perform access class control on the basis of access barring information included in MBMS control information, the chance of connection establishment by the terminals that receive the MBMS service is restricted and accordingly an acceptable chance of successful connection establishment by terminals that do not receive an MBMS service can be maintained.

In the wireless receiving device according to the present embodiment, the MBMS data receiving unit uses a first frequency to receive data, and the random access preamble transmitting unit uses the first frequency to transmit a random access preamble when the result of the access class control permits transmission of a random access preamble, and uses a second frequency to transmit a random access preamble when the result of the access class control prohibits transmission of a random access preamble.

With this configuration, a random access preamble is transmitted with the second frequency different from the first frequency with which the MBMS service is provided. Since different frequencies, the first and second frequencies, are used for transmitting random access preambles, the probability of collision between random access preambles can be reduced.

In the wireless receiving device according to the present embodiment, the control information receiving unit uses RRC protocol to further receive information indicating a preferential frequency to be preferentially used when a random access preamble cannot be transmitted with the first frequency, and the random access preamble transmitting unit transmits a random access preamble by using the preferential frequency as the second frequency when the result of the access class control prohibits transmission of a random access preamble.

This configuration enables a base station to set a preferential frequency for a terminal, thereby controlling the frequency used for transmitting a random access preamble.

The wireless receiving device according to the present embodiment further comprises a priority determining unit determining priority of an MBMS service and priority of a unicast service, wherein when the result of the access class control prohibits the use of the first frequency to transmit an random access preamble, the priority deteinfining unit determines priority of an MBMS service currently being received and priority of a unicast service and, if the priority determining unit determines that the priority of the unicast service is higher than the priority of the MBMS service, the random access preamble transmitting unit uses the second frequency to transmit a random access preamble.

With this configuration, when the priority of the unicast service is higher, the wireless receiving device can switch to the second frequency to quickly start transmitting the random access preamble; when the priority of the MBMS service is higher, the wireless receiving device can continue using the first frequency to receive the MBMS service at the expense of the time required to establish a connection.

A base station device of the present embodiment has the configuration of the wireless transmitting device described above. A terminal device of the present embodiment has the configuration of the wireless receiving device described above. A wireless communication system of the present embodiment comprises the base station device and the terminal device described above.

With this configuration, the base station device provides an MBMS service and the problem associated with the MBMS service that it takes a long time to establish a connection can be solved.

A wireless transmitting method according to the present embodiment comprises a data transmitting step of transmitting MBMS data and a control information transmitting step of transmitting MBMS control information comprising access barring information.

With this configuration, like the wireless transmitting device of the present embodiment described above, the method applies access class control to terminals that receive an MBMS service to maintain an acceptable chance of successful connection establishment by terminals that do not receive the MBMS service.

A wireless receiving method according to the present embodiment comprises a data receiving step of receiving MBMS data, a control information receiving step of receiving MBMS control information comprising access barring information, an access class control step of performing access class control on the basis of the MBMS control information, and a random access preamble transmitting step of transmitting a random access preamble on the basis of a result of the access class control.

With this configuration, like the wireless receiving device of the present embodiment described above, the method applies access class control to terminals that receive an MBMS service on the basis of access barring information included in MBMS control information. Therefore, transmission of random access preambles by the terminals that receive the MBMS service can be restricted to maintain an acceptable chance of successful connection establishment by terminals that do not receive the MBMS service.

Wireless transmitting devices and wireless receiving devices according to embodiments of the present invention will be described below in detail with reference to drawings. A wireless communication system comprising a base station device (hereinafter referred to as “base station”) and terminal devices (hereinafter referred to as “terminals”) will be taken as an example. In the following example, the base station represents a wireless transmitting device and the terminals represent wireless receiving devices. In the embodiments described below, elements having like functions will be given like numerals and repeated description of those elements will be omitted.

The embodiments will be described with respect to Long Term. Evolution (LTE), System Architecture Evolution (SAE), and MBMS, which are mobile communication technologies standardized in 3GPP. However, the present invention is not limited to the standards in 3GPP but is also applicable to wireless access technologies such as WLAN (Wireless Local Area network), WiMAX (Worldwide Interoperability for Microwave Access) in IEEE 802.16, IEEE 802.16e, and IEEE 802.16m, and 3GPP2, the fourth generation mobile communication technology, and other technologies.

### First Embodiment

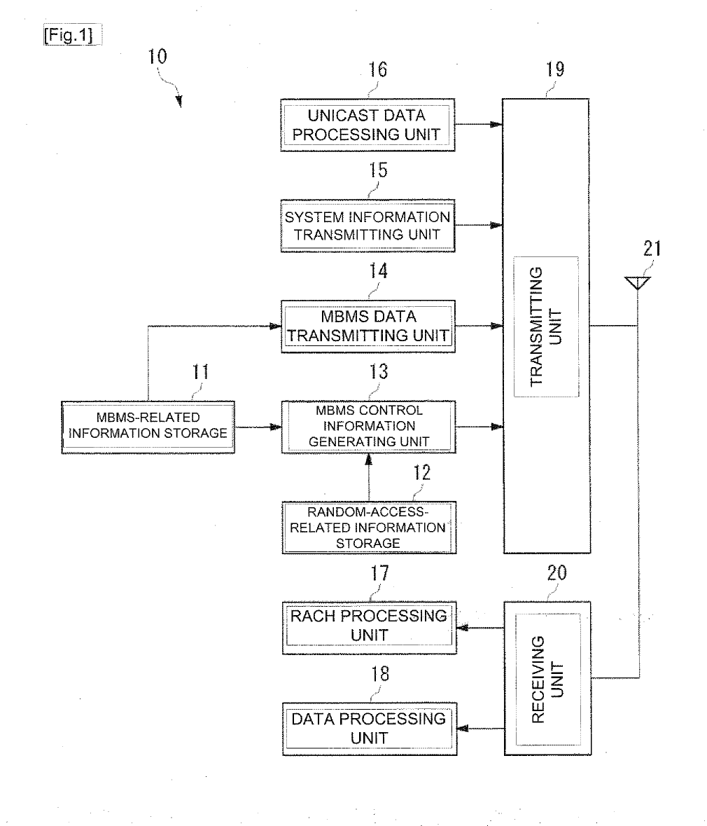

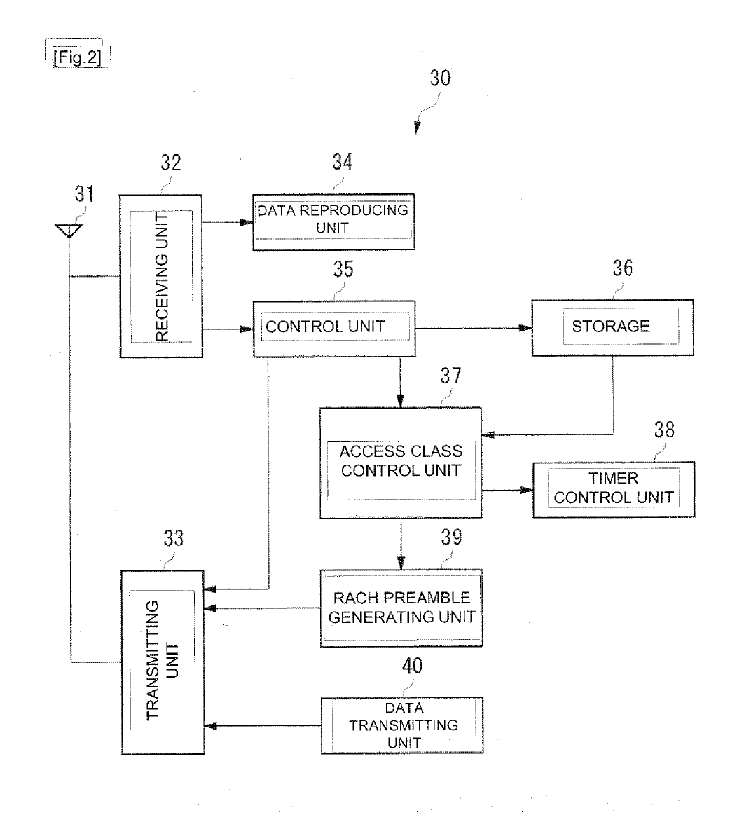

FIG. 1 is a diagram illustrating a configuration of a base station 10 according to a first embodiment. FIG. 2 is a diagram illustrating a configuration of a terminal 30 according to the first embodiment. A configuration of a network to which the base station 10 and the terminal 30 of the first embodiment are applied will be described first before describing the base station 10 and the terminal 30 in detail with reference to FIGS. 1 and 2.

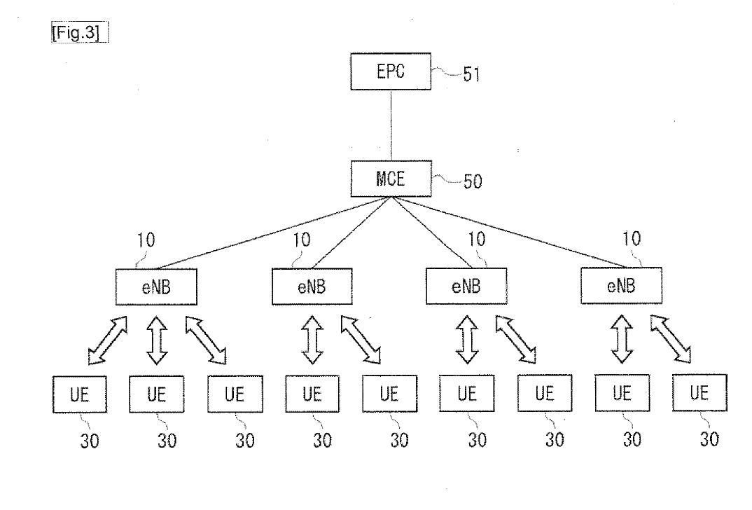

FIG. 3 is a diagram illustrating a configuration of the network relating to the first embodiment of the present invention. The network illustrated in FIG. 3 comprises terminals (User Equipments: UE) 30, base stations (Evolved Nodes B, eNB) 10, an MBMS control device (MBMS Control Entity: MCE) 50, and a core network (Evolved Packet Core: EPC) 51.

Each of the base stations 10 allocates and manages wireless resources and functions as an access point of a wireless access network for terminals 30. The base station 10 receives information transferred from the terminals 30 through uplinks and transfers data to the terminals 30 through downlinks.

The MCE 50 manages multiple base stations 10 and allocates physical resource blocks to MBMS services. The EPC 51, which is the core of the mobile communication network, distributes MBMS contents and controls MBMS data and sessions.

A configuration of the base station 10 will be described with reference to FIG. 1. The base station 10 comprises an MBMS-related information storage 11, a random-access-related information storage 12, an MBMS control information generating unit 13, an MBMS data transmitting unit 14, a system information transmitting unit 15, and a unicast data processing unit 16, as components for transmitting data to the terminals 30. The base station 10 comprises an RACH processing unit 17 and a data processing unit 18 as components that process data received from terminals 30.

The MBMS-related information storage 11 stores control information and data relating to an MBMS service. The random-access-related information storage 12 stores information relating to random access such as access barring information.

The MBMS control information generating unit 13 reads out access barring information from the random-access-related information storage 12 and reads out control information relating to an MBMS service from the MBMS-related information storage 11. The MBMS control information generating unit 13 generates MBMS control information such as service notification information and scheduling information on the basis of the read-out information and outputs the MBMS control information to a transmitting unit 19. The MBMS data transmitting unit 14 processes MBMS data read-out from the MBMS-related information storage 11 and outputs the processed MBMS data to the transmitting unit 19.

The unicast data processing unit 16 outputs unicast data to the transmitting unit 19. The system information transmitting unit 15 outputs system information to the transmitting unit 19.

The transmitting unit 19 sends out information input from the MBMS control information generating unit 13, the unicast data processing unit 16, the MBMS data transmitting unit 14, and the system information transmitting unit 15 through an antenna 21.

The RACH processing unit 17 processes an RACH preamble input from a receiving unit 20. The data processing unit 18 processes data input from the receiving unit 20.

The receiving unit 20 receives an RACH preamble transmitted from a terminal 30 and data transmitted from a terminal 30 and the core network and outputs the RACH preamble and the data to the RACH processing unit 17 and the data processing unit 18, respectively.

A configuration of the terminal 30 will be described below with reference to FIG. 2. The terminal 30 comprises a receiving unit 32 receiving data transmitted from a base station 10 through an antenna 31 and a transmitting unit 33 transmitting data to a base station 10. The receiving unit 32 receives system information, MBMS control information, MBMS data, and unicast data transmitted from a base station 10. The receiving unit 32 inputs the system information and the MBMS control information it received to a control unit 35 and inputs the MBMS data and the unicast data it received to a data reproducing unit 34.

The data reproducing unit 34 reproduces MBMS data and unicast data input from the receiving unit 32. The control unit 35 extracts random-access-control-related information and system information from MBMS control information input from the receiving unit 32 and outputs the random-access-control-related information and the system information to a storage 36. If access barring information is included in the random-access-control-related information, the control unit 35 instructs an access class control unit 37 to perform access class control.

The access class control unit 37 performs access control of RACH preamble transmission. Specifically, the access class control unit 37 generates a random value in response to an instruction from the control unit 35 and compares the random value with an access probability factor. If the comparison shows that the random value is greater than or equal to the access probability factor, the access class control unit 37 instructs a timer control unit 38 to run a barring timer; if the comparison shows that the random value is smaller than the access probability factor, the access class control unit 37 instructs an RACH preamble generating unit 39 to generate an RACH preamble.

The timer control unit 38 calculates and runs a barring timer in response to an instruction from the access class control unit 37 and prohibits transmission of an RACH preamble until the timeout of the barring timer.

The RACH preamble generating unit 39 generates an RACH preamble in response to an instruction from the access class control unit 37 and outputs the RACH preamble to the transmitting unit 33. A data transmitting unit 40 outputs data to be transmitted to a base station 10 to the transmitting unit 33.

The transmitting unit 33 transmits an RACH preamble input from the RACH preamble generating unit 39 and data input from the data transmitting unit 40 to the base station 10.

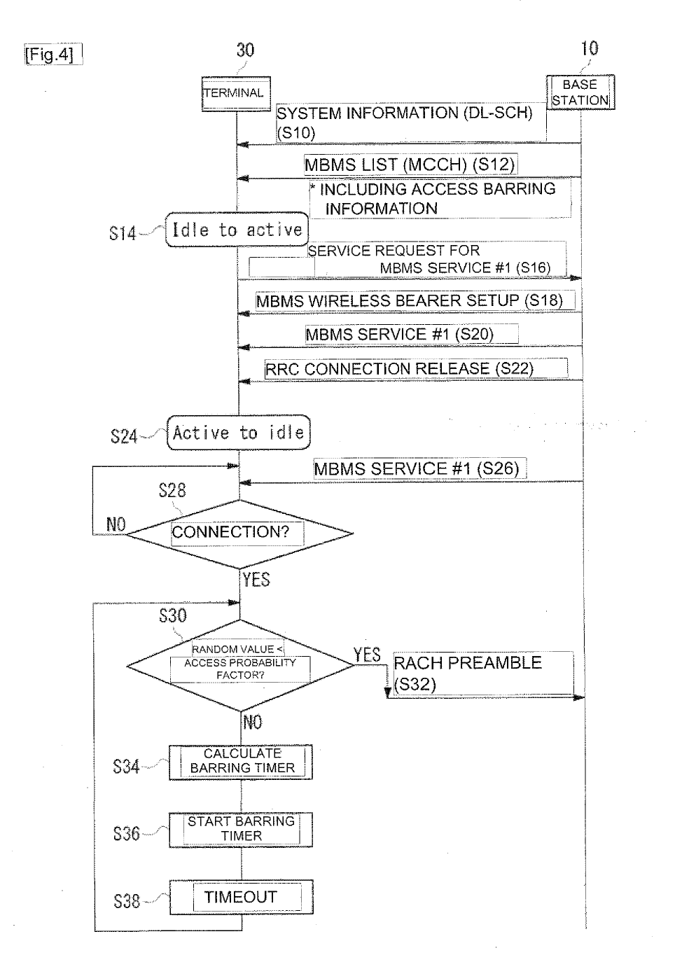

FIG. 4 is a diagram illustrating signaling operations of a base station 10 and a terminal 30 according to the first embodiment of the present invention. The terminal 30 receives system information from the base station 10 through a downlink shared channel (DL-SCH), which is a transport channel (S10). It is assumed here that access barring information is not included in the transmitted system information.

The terminal 30 receives a list of MBMS services available in the cell from the base station 10 through an MBMS control channel (hereinafter abbreviated as “MCCH”), which is a logical channel (S12). The MCCH has been mapped to one of a DL-SCH or a multicast channel (hereinafter abbreviated as “MCH”), which are transport channels.

Here, if the base station 10 has determined to apply access class control to the terminal 30, access barring information is transmitted through the MCCH at the same time as the list of MBMS services available in the cell (S12). The access barring information comprises an access timer flag indicating whether access class control is to be performed or not, an access probability factor used for access class control, and a default value. If the barring timer flag is on, the terminal, if receives an MBMS service, performs access class control prior to transmission of an RACH preamble; if the barring timer flag is off, the terminal does not perform access class control. The access probability factor and the default value are set for all MBMS services in common. Alternatively, an access probability factor and a default value may be set individually for each MBMS service.

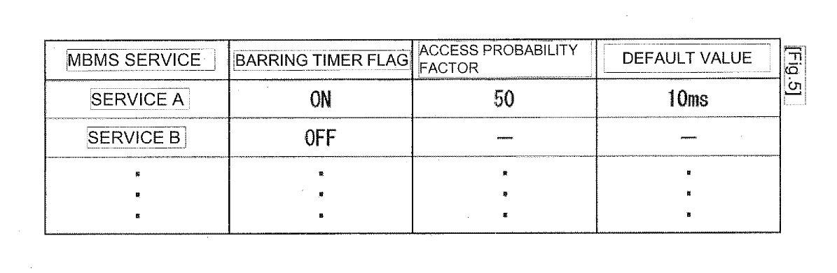

FIG. 5 is a diagram illustrating another example of access barring information. In this example, the access barring information is a barring timer flag associated with each MBMS service. If the barring timer flag is on, an access probability factor and a default value are also associated with the MBMS service as data used for performing access class control. According to these items of access barring information, access class control that differs from one MBMS service to another can be performed.

Referring again to FIG. 4, the description of the signaling will be continued. If an MBMS service that the terminal 30 user wants to receive (here, MBMS service #1) is on the list, the terminal 30 in an idle state establishes a connection to the base station 10, enters an active state (S14) and transmits a service request for MBMS service #1 to the base station 10 (S16).

The base station 10 receives the service request from the terminal 30 and sets up a wireless bearer for the terminal 30 to receive that service (S18). The terminal 30 receives MBMS service #1 through the wireless bearer set up by the base station 10 (S20). Then the base station 10 transmits an RRC connection release message to the terminal 30 (S22). When the terminal 30 receives the message, the terminal 30 returns to the idle state (S24). In consequence, the terminal 30 enters a state in which the terminal 30 is only receiving MBMS service #1. That is, the terminal 30 receives the MBMS service in the idle state. If the desired MBMS service (MBMS service #1) has already been transmitted from the base station 10 to the terminal 30, steps S14, S16 and S18 would be omitted.

Then, the terminal 30, which is receiving MBMS service #1 (S26), determines whether or not an attempt has been made on the terminal 30 to establish a connection to the base station 10 to cause the terminal 30 to enter the active state (S28). For example, if an operation to initiate a call or send mail has been performed on the terminal 30, the terminal 30 determines that an attempt has been made to connect to the base station 10 to cause the terminal 30 to enter the active state. In the example illustrated in FIG. 4, if an attempt has been made to connect to the base station 10 (YES at S28), the terminal 30 performs access class control. The terminal 30 compares a random value generated locally on the terminal 30 with the access probability factor to determine whether or not the random value is smaller than the access probability factor (S30). If the random value is smaller than the access probability factor (YES at S30), the terminal 30 transmits an RACH preamble (S32).

If the random value is greater than or equal to the access probability factor (NO at S30), then the terminal 30 calculates the value of the barring timer (534) and initiates the barring timer (S36). The terminal 30 waits until timeout of the barring timer. Upon timeout of the barring timer, the terminal 30 performs step S30, where the terminal 30 compares a random value with the access probability factor again.

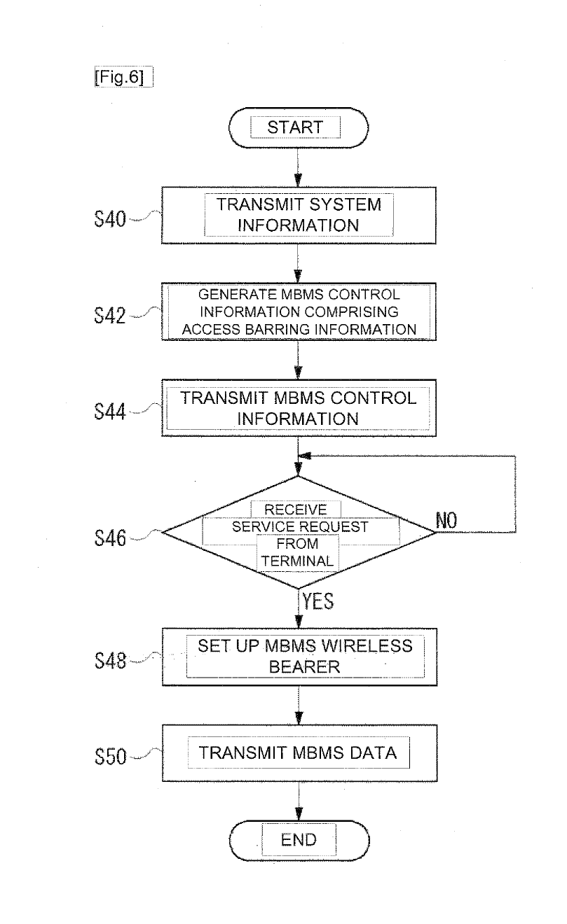

FIG. 6 is a diagram illustrating an operation of the base station 10 that implements signaling between the base station 10 and the terminal 30 described above. The base station 10 transmits system information to the terminal 30 (S40). The base station 10 generates MBMS control information including access barring information (S42) and transmits the generated MBMS control information to the terminal 30 (S44).

Then the base station 10 determines whether or not a service request for an MBMS service has been transmitted from a terminal 30 (S46). If a service request for an MBMS service has been transmitted from a terminal 30, the base station 10 sets up a wireless bearer for the terminal 30 to receive the MBMS service (S48) and transmits MBMS data (S50).

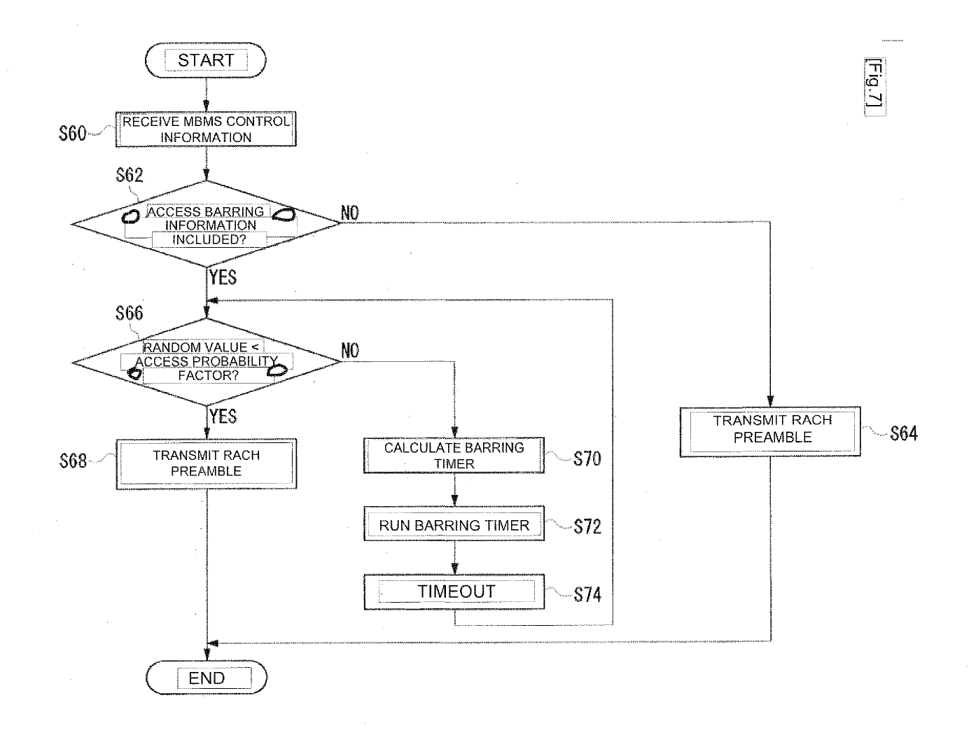

FIG. 7 is a diagram illustrating an operation of the terminal 30 that implements signaling between the base station 10 and the terminal 30 described above. When the terminal 30 receives MBMS control information (S60), the terminal 30 determines whether or not access class barring information is included in the MBMS control information (S62). If access class barring information is not included (NO at S62), the terminal 30 transmits an RACH preamble when attempting to establish a connection to the base station 10 (S64).

If access class barring information is included (YES at S62), the terminal 30 performs access class control prior to transmission of the RACH preamble. First, the terminal 30 compares a random value that the terminal 30 has generated with the access probability factor contained in the MBMS control information to determine whether or not the random value is smaller than the access probability factor (S66). If the comparison shows that the random value is smaller than the access probability factor (YES at S66), the terminal 30 transmits the RACH preamble (S68).

If the random value is greater than or equal to the access probability factor (NO at S66), the terminal 30 calculates the value of the barring timer (S70). The value of the barring timer is calculated by multiplying the default value of the barring timer specified in the access class barring information included in the MBMS control information by a random value generated locally on the terminal 30. The terminal 30 initiates the calculated barring timer (S72) and prohibits transmission of the RACH preamble while the barring timer is running. Upon timeout of the barring timer (S74), the terminal 30 compares a random value locally generated on the terminal with the access probability factor again (S66). The configurations and operations of the base station 10 and the terminal 30 of the first embodiment have been described thus far.

Since the base station 10 of the first embodiment specifies in the MBMS control information whether access class control is to be performed or not, only the terminals 30 that receive an MBMS service perform access class control when the terminals 30 transmit an RACH preamble. Accordingly, collisions between RACH preambles can be reduced without affecting terminals 30 that do not receive the MBMS service.

Furthermore, since access barring information is transmitted in MBMS control information, the access barring information can be provided only to the terminals that receive the MBMS service with a simple configuration.

While the present embodiment has been described with respect to an example in which access barring information includes a barring timer flag indicating whether access class control is to be performed for each MBMS service, MBMS control information that does not include a barring timer flag may be used. If access barring information does not include a barring timer flag, terminals 30 that receive any of the MBMS service on the list will perform access class control.

### Second Embodiment

A second embodiment of the present invention will be described below. A base station 10 of the second embodiment has the same configuration as the base station 10 of the first embodiment.

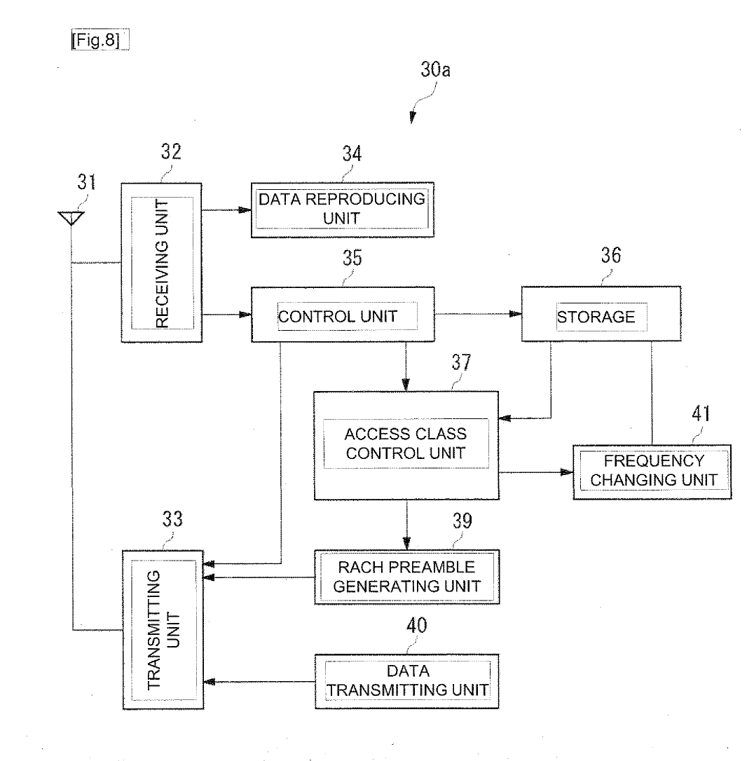

FIG. 8 is a diagram illustrating a configuration of a terminal 30a according to the second embodiment. The configuration of the terminal 30a of the second embodiment is basically the same as the configuration of the terminal 30 of the first embodiment, except that the terminal 30a of the second embodiment comprises a frequency changing unit 41 which changes frequency with which an RACH preamble is transmitted.

An access class control unit 37 generates a random value in response to an instruction from a control unit 35 and compares the value with an access probability factor. If the comparison shows that the random value is smaller than the access probability factor, the access class control unit 37 instructs an RACH preamble generating unit 39 to generate an RACH preamble. If the random value is greater than or equal to the access probability factor, the access class control unit 37 instructs the frequency changing unit 41 to change frequency.

When there is preferential frequency information output from a storage 36, the frequency changing unit 41 switches to that frequency. When there is not preferential frequency information, the frequency changing unit 41 reselects a frequency on the basis of frequency information included in system information output from the storage 36 indicating the frequency to be preferentially selected by the terminal 30a.

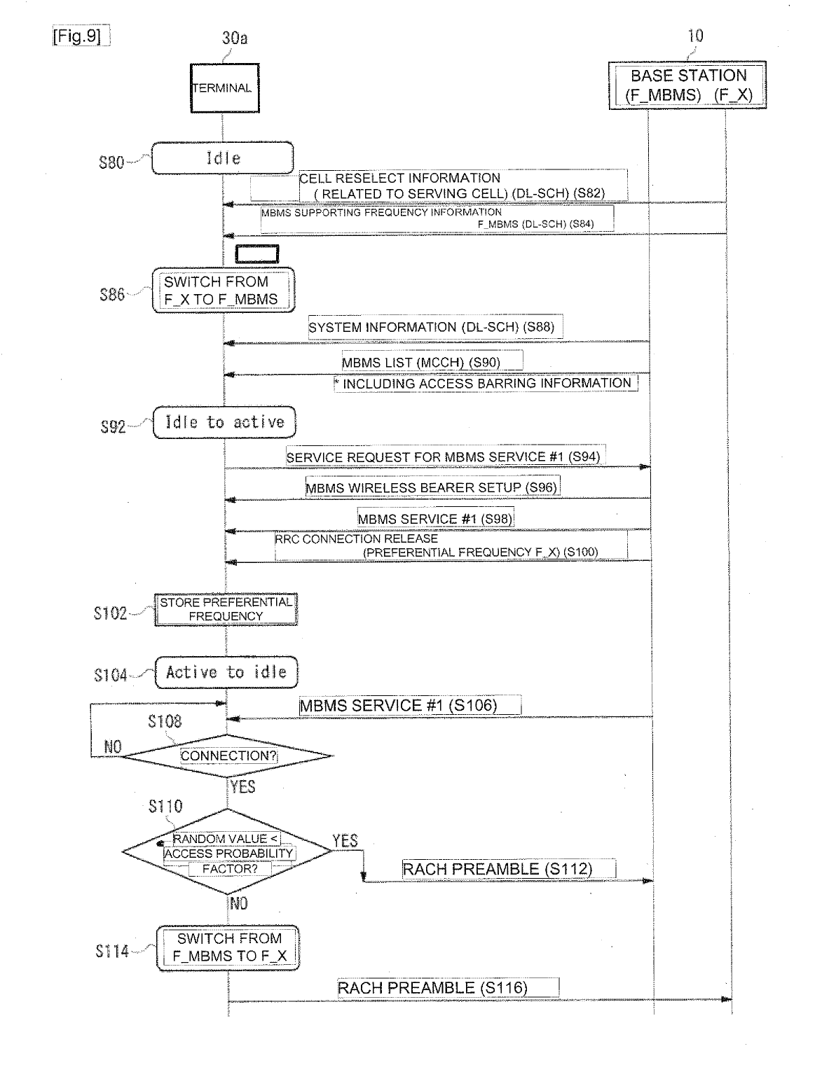

FIG. 9 is a diagram illustrating signaling between a terminal 30a and a base station 10 in the second embodiment. In FIG. 9, it is assumed that the base station 10 manages multiple frequencies (f_x and f_mbms) and the terminal 30a in an idle state is camped on frequency f_x and receiving system information and paging (S80).

The terminal 30a receives the system information through a downlink shared channel (DL-SCH), which is a transport channel, with frequency f_x (S82). In the system information, frequency information indicating a frequency to be preferentially selected by the terminal 30a when the terminal 30a reselects a cell and information indicating a frequency that supports an MBMS service is transmitted (S84). Here, it is assumed that access barring information has not been transmitted in the system information.

When the terminal 30a receives the MBMS supporting frequency information in the system information, the terminal 30a camps on the MBMS supporting frequency (f_mbms) from the current frequency (f_x) (S86). As a result, the terminal 30a receives system information and paging by using frequency f_mbms (S88).

The terminal 30a receives a list of MBMS services available in the cell from the base station 10 through an MCCH, which is a logical channel (S90). The MCCH has been mapped to one of a DL-SCH or MCH, which are transport channels. Here, if the base station 10 has determined to apply access class control to the MBMS terminal 30a, the base station 10 transmits access barring information to the terminal 30a through the MCCH at the same time as the list of MBMS services available in the cell. The access barring information is the same as the access barring information transmitted from the base station 10 in the first embodiment.

If an MBMS service that the terminal 30a user wants to receive (here MBMS service #1) is on the list, the terminal 30a in an idle state establishes a connection to the base station 10 to enter an active state (S92) and transmits a service request for MBMS service #1 to the base station 10 (S94). When the base station 10 receives the service request from the terminal 30a, the base station 10 sets up a wireless bearer for the terminal 30a to receive that service (S96). The terminal 30a receives MBMS service #1 through the wireless bearer set up by the base station 10 (S98).

Then, the base station 10 transmits an RRC connection release message to the terminal 30a (S100). When the terminal 30a receives the message, the terminal 30a returns to the idle state (S104). The RRC connection release message indicates a frequency (here, f_x) that the terminal 30a is to preferentially select after the terminal 30a enters the idle state. The aim of this is to allocate different frequencies among terminals 30a that attempt to connect to the base station 10, thereby avoiding overloading any one frequency with many connections. Here, however, the terminal 30a does not switch to the preferential frequency (f_x) specified by the base station 10 but remains at the MBMS supporting frequency (f_mbms) in order to receive the MBMS service. The terminal 30a stores the preferential frequency (f_x) specified by the base station 10 in a storage 36 (S102). If the desired MBMS service (MBMS service #1) has already been transmitted from the base station 10, steps S92, S94, S96 and S100 would be omitted.

In the example illustrated in FIG. 9, the terminal 30a, which is receiving MBMS service #1, determines whether the terminal 30a is to establish a connection to the base station 10 to enter the active state (S108). If the terminal 30a determines that the terminal 30a is to connect to the base station 10 (YES at S108), the terminal 30a performs access class control.

The terminal 30a compares a random value locally generated on the terminal 30a with the access probability factor to determine whether the random value is smaller than the access probability factor (S110). If the random value is smaller than the access probability factor (YES at S110), the terminal 30a transmits an RACH preamble (S112).

If the random value is greater than or equal to the access probability factor (NO at S110), the terminal 30a reads out information indicating the preferential frequency (f_x) from the storage 36, switches to the read out preferential frequency (f_x) (S114), and transmits an RACH preamble with the preferential frequency (f_x) (S116). If information indicating the preferential frequency (f_x) is not stored in the storage 36, the terminal 30a reselects a frequency on the basis of information transmitted in the system information that indicates a frequency to be preferentially selected by the terminal 30a.

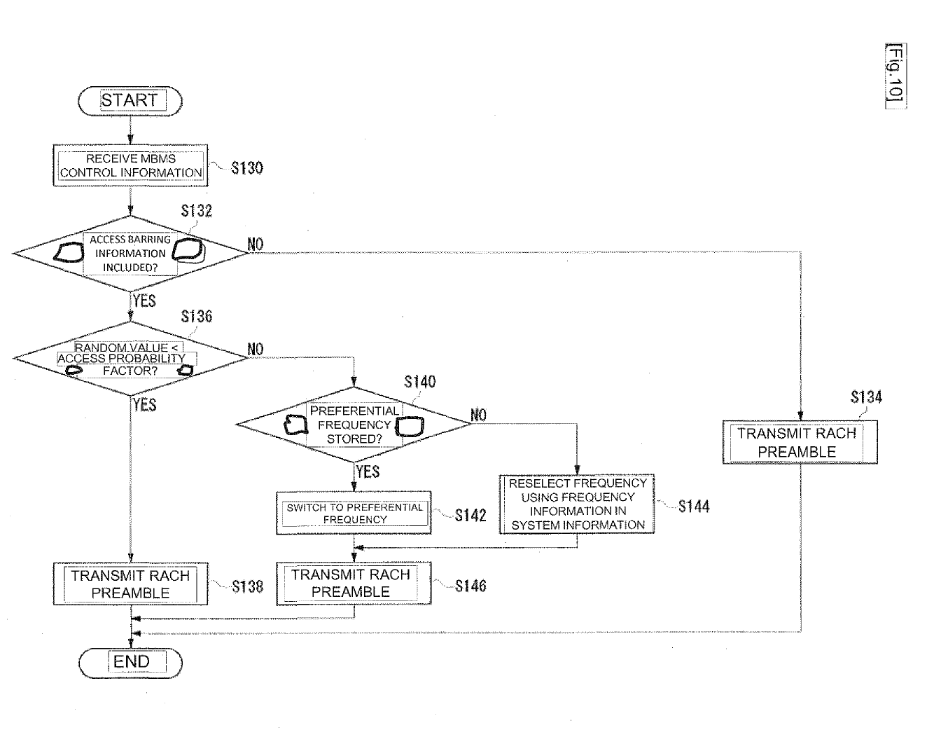

FIG. 10 is a diagram illustrating an operation of the terminal 30a that implements signaling between the terminal 30a and the base station 10 described above. When the terminal 30a receives MBMS control information (S130), the terminal 30a determines whether or not access class barring information is included in the MBMS control information (S132). If access class barring information is not included (NO at S132), the terminal 30a transmits an RACH preamble (S134).

If access class barring information is included (YES at S132), the terminal 30a performs access class control. In the access class control, the terminal 30a first generates a random value and compares the generated random value with the access probability factor (S136). If the random value is smaller than the access probability factor (YES at S136), the terminal 30a transmits an RACH preamble (S138).

The random value is greater than or equal to the access probability factor (NO at S136), the terminal 30a changes frequency. The terminal 30a determines whether or not a preferential frequency has been specified in the RRC connection release message when the RRC connection has been released by the base station 10. If a preferential frequency is specified, that is, a preferential frequency is stored in the storage 36 (YES at S140), the terminal 30a switches to that frequency (S142) and transmits an RACH preamble (S146).

If a preferential frequency is not specified, that is, a preferential frequency is not stored in the storage 36 (NO at S140), the terminal 30a reselects a frequency on the basis of information included in the system information that indicates a frequency to be preferentially selected by the terminal 30a (S144). After switching to the newly selected frequency, the terminal 30a transmits an RACH preamble (S146). The configurations and operations of the base station 10 and the terminal 30a of the second embodiment have been described thus far.

Since each of the terminals 30a of the second embodiment uses a different preferential frequencies specified individually by the base station 10 when a random value generated locally on the terminal 30a in access class control is smaller than an access probability factor, congestion on a particular frequency can be avoided and collisions between RACH preambles can be reduced.

In the embodiment described above, if the terminal 30a is originally in a cell that supports MBMS, MBMS supporting frequency does not need to be transmitted in system information.

### Third Embodiment

A base station 10 and a terminal 30b of a third embodiment will be described below. The base station 10 and the terminal 30b in the third embodiment have basically the same configurations as the base station 10 and the terminal 30a in the second embodiment. The terminal 30b of the third embodiment differs from the terminal 30a of the second embodiment in that the terminal 30b of the third embodiment performs RACH preamble access control depending on the priorities of MBMS services and a unicast services.

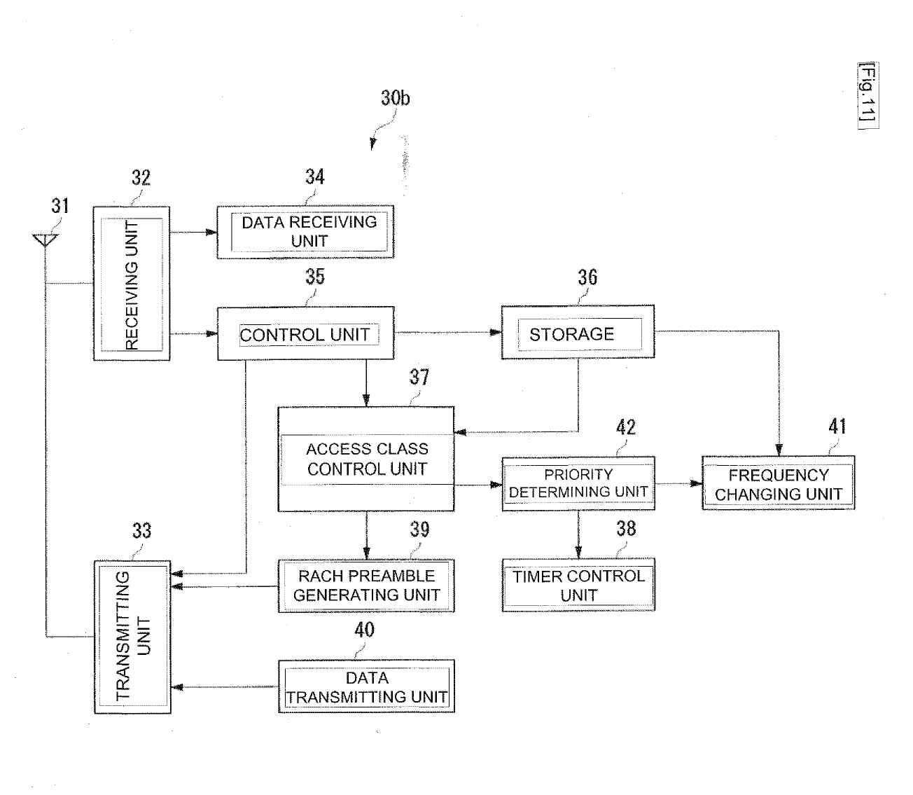

FIG. 11 is a diagram illustrating a configuration of the terminal 30b of the third embodiment. The terminal 30b of the third embodiment comprises a priority determining unit 42 and a timer control unit 38 in addition to the components of the terminal 30a of the second embodiment.

An access class control unit 37 generates a random value in response to an instruction from a control unit 35 and compares the random value with an access probability factor. If the comparison shows that the random value is greater than or equal to the access probability factor, the access class control unit 37 instructs the priority determining unit 42 to determine the order of priorities; if the random value is smaller than the access probability factor, the access class control unit 37 instructs an RACH preamble generating unit 39 to generate an RACH preamble.

The priority determining unit 42 compares the priority of the unicast service and the priority of MBMS services. If the priority of the unicast service is higher, the priority determining unit 42 instructs a frequency changing unit 41 to change frequency. If the priority of the MBMS services is higher, the priority determining unit 42 instructs the timer control unit 38 to run a timer.

If information indicating a preferential frequency is stored in a storage 36, the frequency changing unit 41 switches to that frequency. If information indicating a preferential frequency is not stored in the storage 36, the frequency changing unit 41 reads out system information from the storage 36 and reselects a frequency on the basis of information in the read-out system information that indicates a frequency to be preferentially selected by the terminal 30b.

The timer control unit 38 calculates and runs a barring timer in response to an instruction from the priority determining unit 42 and prohibits transmission of the RACH preamble until expiration of the barring timer.

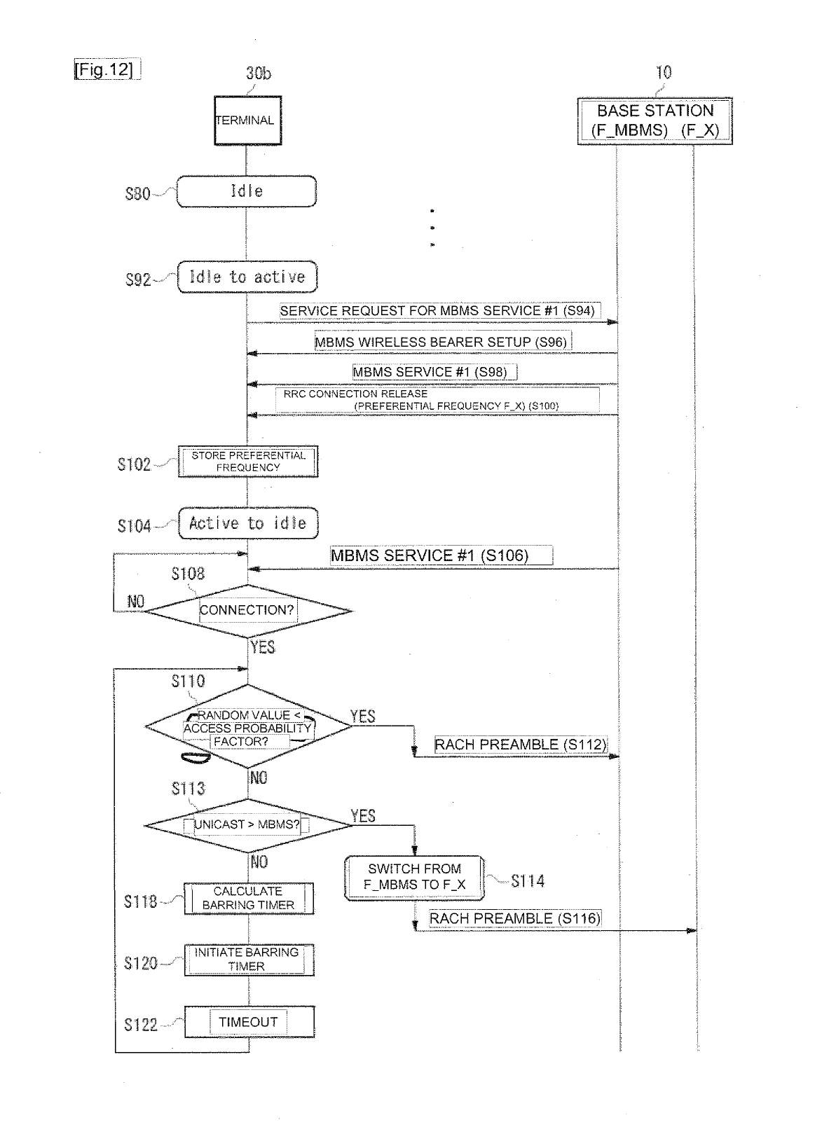

FIG. 12 is a diagram illustrating signaling operations of a base station 10 and a terminal 30b according to the third embodiment. The operations are the same as the signaling operations in the second embodiment until the terminal 30b receives an MBMS service (S80 to S106).

When the terminal 30b, which is receiving MBMS service #1, attempts to establish a connection to the base station 10 and switches to an active state (YES at S108), the terminal 30b performs access class control. In the access class control, the terminal 30b first compares a random value locally generated on the terminal 30b with an access probability factor to determine if the random value is smaller than the access probability factor (S110). If the random value is smaller than the access probability factor (YES at S110), the terminal 30b transmits an RACH preamble (S112).

If the random value is greater than or equal to the access probability factor (NO at S110), the terminal 30b compares the priority of the unicast service with the priority of the MBMS services (S113). The priorities of the services may be set by the user in advance or by the base station 10. If the comparison between the priorities of the services shows that the priority of the unicast service is higher (YES at S113), the terminal 30b reads out information indicating a preferential frequency (f_x) from the storage 36, switches to the read-out preferential frequency (f_x) (S114), and transmits an RACH preamble with the frequency (f_x) (S116). If information indicating a preferential frequency is not stored in the storage 36, the terminal 30b reselects a cell on the basis of frequency information transmitted in system information that indicates a frequency to be preferentially selected by the terminal 30b.

If the priority of the MBMS services is higher than that of the unicast service (NO a S113), the terminal 30b calculates the value of a barring timer (S118), initiates the barring timer (S120), and waits until the timeout of the barring timer. Upon the timeout of the barring timer (S122), the terminal 30b returns to step S110, where a random value is compared with and the access probability factor.

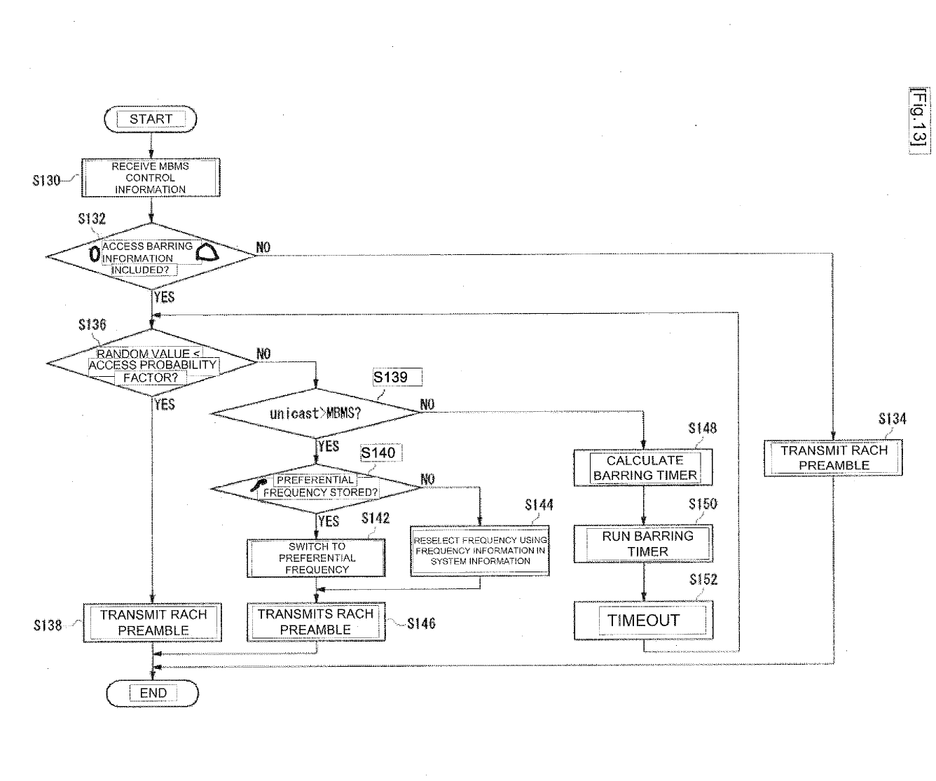

FIG. 13 is a diagram illustrating an operation of the terminal 30b that implements signaling between the terminal 30b and the base station 10 described above. When the terminal 30b receives MBMS control information (S130), the terminal 30b determines whether or not access barring information is included in the MBMS control information (S132). If access class barring information is not included (NO at S132), the terminal 30b transmits an RACH preamble (S134).

If access class barring information is included (YES at S132), the terminal 30b performs access class control. In the access class control, the terminal 30b locally generates a random value first and compares the random value with the access probability factor to determine whether the random value is smaller than the access probability factor (S136). If the random value is smaller than the access probability factor (YES at S136), the terminal 30b transmits an RACH preamble (S138).

If the random value is greater than or equal to the access probability factor (NO at S136), the terminal 30b compares the priorities of the unicast service and the MBMS services (S139). If the priority of the unicast service is higher (YES at S139), the terminal 30b changes frequency. The terminal 30b determines whether or not a preferential frequency has been specified in an RRC message by the base station 10 when the RRC connection has been released (S140). If a preferential frequency is specified (YES at S140), the terminal 30b switches to the frequency (S142) and transmits an RACH preamble (S146).

If a preferential frequency is not specified (NO at S140), the terminal 30b reselects a frequency on the basis of information in system information that indicates a frequency to be preferentially selected by the terminal 30b (S144). The terminal 30b switches to the newly selected frequency and then transmits an RACH preamble (S146).

If the priority of the MBMS services is higher (NO at S139), the terminal 30b calculates the value of a barring timer (S148). The value of the barring timer is calculated by multiplying the default value of the barring timer specified in access class barring information in MBMS control information by a random value generated locally on the terminal. The terminal 30b runs the calculated barring timer (S150) and prohibits transmission of an RACH preamble while the barring timer is running. Upon timeout of the barring timer (S152), the terminal 30b again compares a random value generated locally on the terminal with the access probability factor (S136). The configurations and operations of a base station 10b and a terminal 30b of the third embodiment have been described thus far.

According to the third embodiment, each terminal 30b can select and give priority to transmission of an RACH preamble or reception of the MBMS service, on the basis of which of the priorities of the unicast service and the MBMS services is higher.

When RACH preamble transmission is selected the RACH preamble is transmitted with a preferential frequency specified by the base station 10 and therefore collisions between RACH preambles can be reduced.

In the embodiment described above, a priority may be set for each MBMS service and the set priority may be compared with the priority of the unicast service. This enables more detailed control in which for example when the service being received is service “A”, the unicast service is given priority over MBMS service “A” and switching is made to the unicast service, or when the service being received is MBMS service “B”, MBMS service “B” is given priority over the unicast service to continue receiving MBMS service “B”.

In the embodiment described above, RACH preamble access control may be performed according to, for example, the amount of downlink resources required by the terminal 30b. For example, instead of the comparison between the priorities of MBMS and unicast services at S139 in FIG. 13, the amount of downlink resources currently being used by the terminal 30b may be compared with an amount of resources specified at the base station 10 and, if the amount of downlink resources being used is greater than the specified amount, the value of the barring timer may be calculated (S148). If the amount of downlink resources being used is smaller than the specified amount, frequency may be changed. Alternatively, a combination of the amount of downlink resources being used and the priorities of MBMS and unicast services may be used.

In the embodiment described above, both of the unicast service and the MBMS service may be performed. For example, if the unicast service and the MBMS service have the same priority such as “high priority”, or if the difference in priority between the unicast service and the MBMS service is small, both of the unicast and MBMS services may be performed.

While embodiments of the present invention that are preferable as of the date of preparation of this application have been described above, it will be understood that various modifications can be made to the embodiments and it is intended to cover in the attached claims all such modifications and variations as fall within the true spirit and scope of the present invention.

### INDUSTRIAL APPLICABILITY

The present invention has the advantageous effect of making it possible to provide an MBMS service while maintaining an acceptable chance of successful connection establishment by terminals that do not receive MBMS services. The present invention is useful in applications such as base stations providing MBMS services and terminals receiving the MBMS services.

### REFERENCE SIGNS LIST

10 Base station
11 MBMS-related information storage
12 Random-access-related information storage
13 MBMS control information generating unit
14 MBMS data transmitting unit
15 System information transmitting unit
16 Unicast data processing unit
17 RACH processing unit
18 Data processing unit
19 Transmitting unit
20 Receiving unit
21 Antenna
30 Terminal
31 Antenna
32 Receiving unit
33 Transmitting unit
34 Data reproducing unit
35 Control unit
36 Storage
37 Access class control unit
38 Timer control unit
39 RACH preamble generating unit
40 Data transmitting unit

1-12. (canceled)

13. A wireless transmitting device comprising:
a data transmitting unit transmitting MBMS data; and
a control information transmitting unit transmitting MBMS control information comprising access barring information.

14. The wireless transmitting device according to claim 13, wherein the access barring information is information that enables different access class controls for different MBMS services.

15. The wireless transmitting device according to claim 13, wherein the access barring information is information that can comprise priority of each of the MBMS services.

16. A wireless receiving device comprising:
a data receiving unit receiving MBMS data;
a control information receiving unit receiving MBMS control information comprising access barring information;
an access class control unit performing access class control on the basis of the MBMS control information; and
a random access preamble transmitting unit transmitting a random access preamble on the basis of a result of the access class control.

17. The wireless receiving device according to claim 16, wherein:
the MBMS data receiving unit uses a first frequency to receive data; and
the random access preamble transmitting unit uses the first frequency to transmit a random access preamble when the result of the access class control permits transmission of a random access preamble, and uses a second frequency to transmit a random access preamble when the result of the access class control prohibits transmission of a random access preamble.

18. The wireless receiving device according to claim 17, wherein:
the control information receiving unit uses RRC protocol to further receive information indicating a preferential frequency to be preferentially used when a random access preamble cannot be transmitted with the first frequency; and
the random access preamble transmitting unit transmits a random access preamble by using the preferential frequency as the second frequency when the result of the access class control prohibits transmission of a random access preamble.

19. The wireless receiving device according to claim 17, further comprising a priority determining unit determining priority of an MBMS service and priority of a unicast service, wherein:
when the result of the access class control prohibits the use of the first frequency to transmit an random access preamble, the priority determining unit determines priority of an MBMS service currently being received and priority of a unicast service and, if the priority determining unit determines that the priority of the unicast service is higher than the priority of the MBMS service, the random access preamble transmitting unit uses the second frequency to transmit a random access preamble.

20. A base station device comprising a wireless transmitting device according to claim 13.

21. A terminal device comprising a wireless receiving device according to claim 16.

22. A wireless communication system comprising a base station device according to claim 20 and a terminal device comprising a wireless receiving device comprising a data receiving unit receiving MBMS data; a control information receiving unit receiving MBMS control information comprising access barring information; an access class control unit performing access class control on the basis of the MBMS control information; and a random access preamble transmitting unit transmitting a random access preamble on the basis of a result of the access class control.

23. A wireless transmitting method comprising:
a data transmitting step of transmitting MBMS data; and
a control information transmitting step of transmitting MBMS control information comprising access barring information.

24. A wireless receiving method comprising:
a data receiving step of receiving MBMS data;
a control information receiving step of receiving MBMS control information comprising access barring information;
an access class control step of performing access class control on the basis of the MBMS control information; and
a random access preamble transmitting step of transmitting a random access preamble on the basis of a result of the access class control.
